(19) United States
(12) Patent Application Publication
(10) Pub. No.: US 2015/0149316 A1
(43) Pub. Date: May 28, 2015

(54) Method and System of Conducting Online Group Purchase

(71) Applicant: Taobaby Ltd., Taipei (TW)

(72) Inventor: Chien Hao CHEN, Taipei (TW)

(73) Assignee: Taobaby Ltd., Taipei (TW)

(21) Appl. No.: 14/200,326

(22) Filed: Mar. 7, 2014

(30) Foreign Application Priority Data
Nov. 26, 2013 (TW) 102143035

(51) Int. Cl. G06Q 30/06

(52) U.S. Cl. CPC G06Q 30/0605; G06Q 30/0635
USPC 705/26.2

(57) ABSTRACT

A method and system of conducting online group purchase is implemented through a computer network including a seller's computer device and a purchaser's terminal device. The method includes showing a product on a website and displaying an initial price and a time period of an online sale of the product, starting a time counter, tracking and displaying a cumulative total quantity of the product currently ordered by all purchasers since the beginning of the online sale, and updating in real time the cumulative total quantity each time a new order is received from a new purchaser. When the cumulative quantity reaches a volume threshold value, a discounted price is released for the product, which is displayed on the website. Once the time period of the online sale has elapsed, all the purchasers are notified to proceed to payment based on the discounted price.

### CROSS-REFERENCE TO RELATED APPLICATION

This application claims priority to Taiwan Patent Application No. 102143035 filed on Nov. 26, 2013, which is incorporated herein by reference.

### BACKGROUND

1. Field of the Invention

The present invention relate to a method and system of conducting online group purchase.

2. Description of the Related Art

It is presently common to use computer devices to purchase products through the internet. For the consumer, shopping through the internet can be easy, convenient and time-saving. With respect to a selling party, it may save the cost of setting an actual store and allow to reach customers without any geographic restrictions. However, most of the current internet shopping platforms offer products for sales at fixed prices, and a purchasing party can place an order if he or she accepts the offered price. This business model is not flexible, and fails to provide bargaining power to consumers to obtain cheaper prices.

Therefore, there is a need for a method and system that can address at least the aforementioned issues.

### SUMMARY

The present application describes a method and system of conducting group purchase through a computer network including a seller's computer device and one or more purchaser's terminal devices. In one embodiment, the method includes displaying on a website the image of a product, a time period of an online sale of the product, and a first unit price as a selling price of the product. Then a time counter starts counting. The method further includes receiving an order of the product through the website, displaying a cumulative total quantity of the product currently ordered by all purchasing parties since the beginning of the online sale of the product, and according to the received order updating in real time the cumulative total quantity of the product displayed on the website. When the cumulative total quantity of the product reaches a volume threshold value, a second unit price is applied as the selling price of the product and is displayed on the website. When the time counter reaches an end of the time period of sale of the product, a confirmation message is sent to one or more purchaser's terminal devices requesting payment for the ordered product calculated according to the second unit price.

The present application also describes a system of conducting online group purchase. The system includes a memory, a communication interface, and a processing unit operable to communicate with one or more purchaser's terminal device through the communication interface. The processing unit is operable to execute a computer program stored in the memory, wherein the computer program when executed causes the processing unit to display on a website the image of a product, a time period of an online sale of the product, and a first unit price as a selling price of the product, start a time counter, receive an order of the product and display a cumulative total quantity of the product currently ordered by all purchasing parties since the beginning of the online sale of the product, and according to the received order update in real time the cumulative total quantity of the product displayed on the website. When the cumulative total quantity of the product reaches a volume threshold value, the processing unit applies and displays a second unit price as the selling price of the product, and when the time counter reaches an end of the time period of the online sale of the product, the processing unit sends a confirmation message to one or more purchaser's terminal devices requesting payment for the ordered product calculated according to the second unit price.

### BRIEF DESCRIPTION OF THE DRAWINGS

FIG. 1 is a schematic view illustrating an embodiment of a system of conducting online group purchase;

FIG. 2 is a schematic view illustrating an example of a website that may serve as a platform for conducting online group purchase;

FIG. 3 is a schematic view illustrating a variant embodiment of the website;

FIG. 4 is a flowchart of illustrating method steps implemented through the system shown in FIG. 1 to conduct online group purchase; and

FIG. 5 is a schematic view illustrating an embodiment of a seller's computer device.

### DETAILED DESCRIPTION OF THE EMBODIMENTS

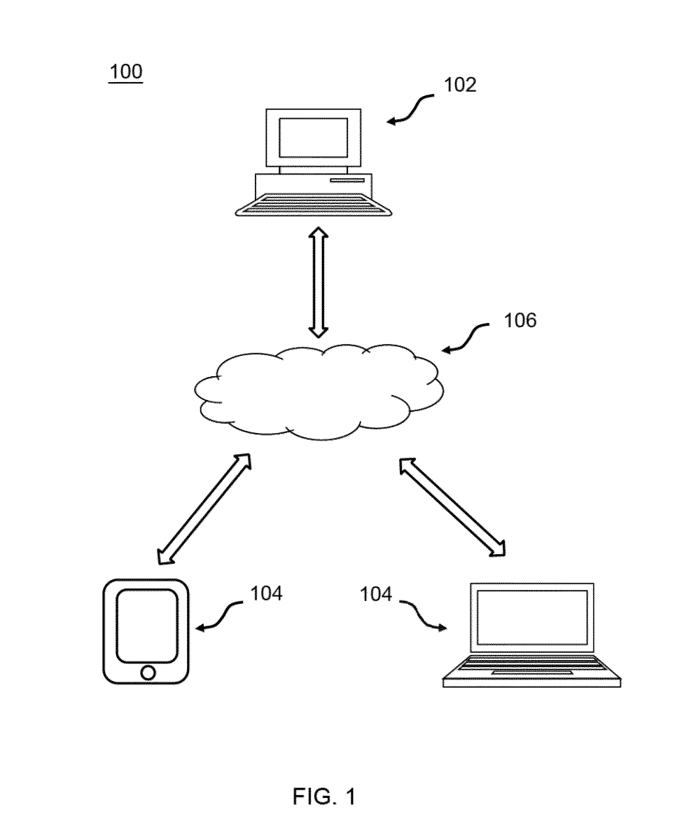

FIG. 1 is a schematic view illustrating an embodiment of a system 100 of conducting online group purchase through a computer network. The system 100 can include a seller's computer device 102, and a plurality of purchaser's terminal devices 104 that can communicate and exchange data with the seller's computer device 102 via a computer network 106. Examples of the computer network 106 can include Internet network, Local Area Network, and the like. Examples of the seller's computer device 102 can include a desktop computer, a laptop computer and the like. The seller's computer device 102 can be located at the site of a manufacturer, a dealer, a distributor, or like trade companies. The terminal devices 104 can be any computing devices, such as a desktop computer, a laptop computer, a tablet computer, a smartphone, etc. A selling party can set up a website through the seller's computer device 102, and can use the website as a platform to conduct commercial transactions with the purchaser's terminal devices 104.

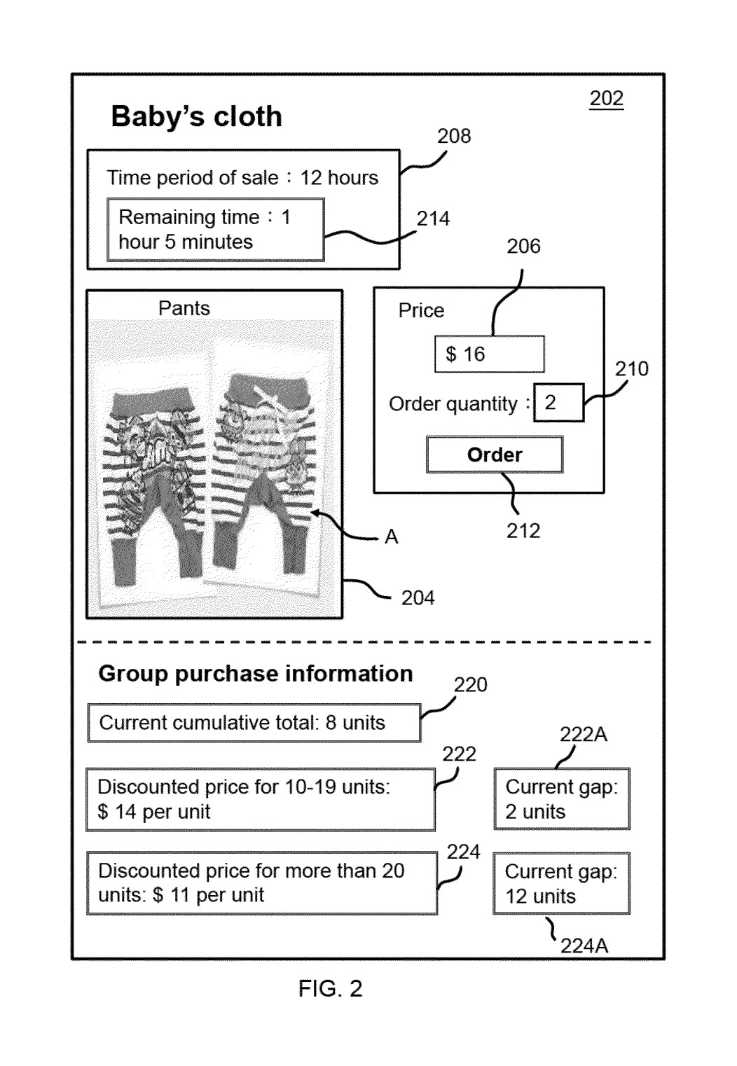

FIG. 2 is a schematic view illustrating an example of a website 202 that may serve as a platform for conducting online group purchase. The content of the website 202 can include a product image 204, a plurality of fields 206, 208 and 210 containing information related to the sales of a product, and an order icon 212. More specifically, the product image 204 can show a product A that is offered for sales. The field 206 can display a selling price of the product A. The field 208 can display a time period of an online sale of the product A, which is the period of time during which the product A is offered for online sale. The time period information shown in the field 208 can be preset by the selling party, and can exemplary range from a few hours to several days. The field 210 indicates an order quantity: a purchasing party can input a quantity of the product A he or she wants to order in the field 210, and then hit the order icon 212 to transmit the order.

In some embodiment, the website 202 may also include a time counter 214 to inform a purchasing party about an elapsed time or a remaining time of online sale of the product A.

Referring again to FIG. 2, the website 202 can further include a plurality of data fields 220, 222, 224, 222A and 224A that can facilitate online group purchase transactions. For example, the field 220 can display a cumulative total quantity of the product A, which is the total quantity of the product A currently ordered by all purchasing parties since the beginning of the online sale of the product A. As new orders are placed through the website 202, the content of the field 220 can be updated and displayed in real time.

The fields 222 and 224 can show different per unit discount prices of the product A that may be respectively applied under certain conditions. For example, the content of the field 222 can indicate that the selling price of the product A can be decreased to a discounted unit price P1 (e.g., $14) lower than the initial price (e.g., $16) when the cumulative total quantity of the product A tracked in the field 220 is equal to or greater than a predetermined volume threshold value T1 (e.g., 10 units). The content of the field 224 can indicate that the selling price of the product A can be further reduced to another discounted unit price P2 (e.g., $11) lower than the discounted unit price P1 when the cumulative total quantity tracked in the field 220 is equal to or greater than another predetermined volume threshold value T2 (e.g., 20 units), T2 being greater than T1.

The fields 222A and 224A can respectively display in real time the respective gaps between the volume threshold values T1, T2 and the cumulative total quantity of the product A currently ordered by all purchasing parties since the beginning of the online sale of the product A. For example, the gap value shown in the field 222A can be the current difference between the volume threshold value T1 and the cumulative total quantity of the product A currently ordered by all purchasing parties since the beginning of the online sale of the product A (e.g., assuming that T1 is equal to 10 units, and the cumulative total quantity of the product A is 8, the value displayed in the field 222A is equal to 2). Likewise, the gap value shown in the field 224A can be the current difference between the volume threshold value T2 and the cumulative total quantity of the product A currently ordered by all purchasing parties since the beginning of the online sale of the product A (e.g., assuming that T2 is equal to 20 units, and the cumulative total quantity of the product A is 8, the value displayed in the field 224A is equal to 12). Accordingly, any party can browse the website 202 through one terminal device 104, access to the current sale status of the product A in real time, and decide a suitable order quantity so as to obtain a discounted group purchase price.

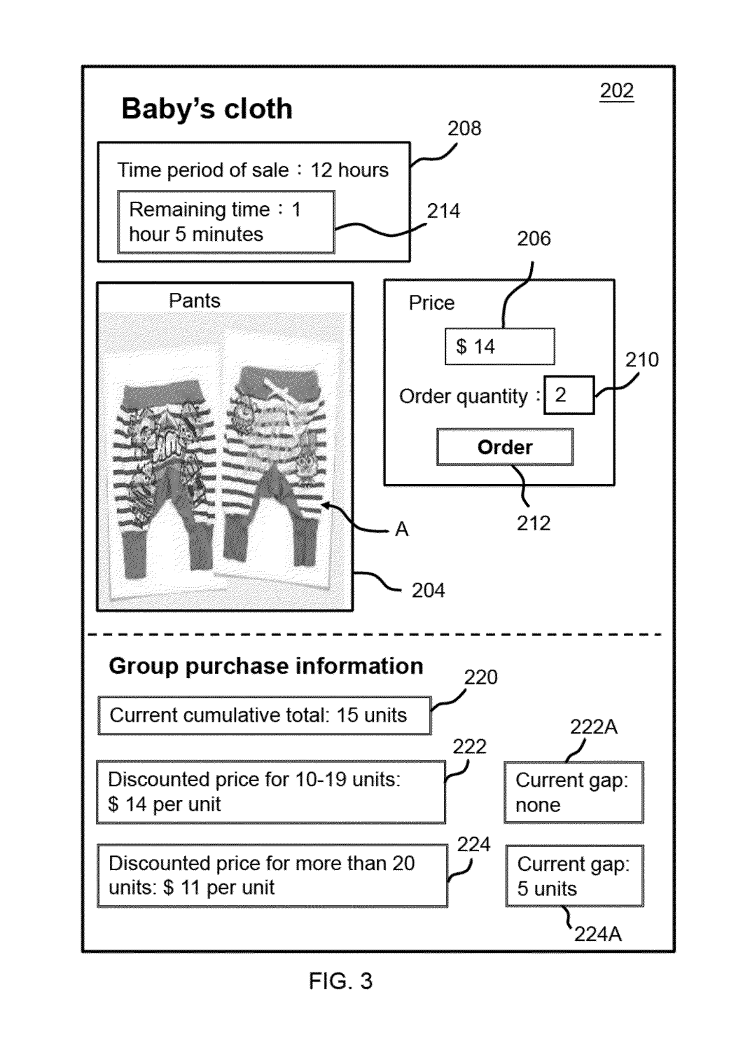

In one embodiment, the field 206 can constantly display the same initial unit price of the product A set at the beginning of the online sale, and remains unchanged regardless of the increase of the cumulative total quantity of the product A currently ordered by all purchasing parties. In other embodiments, the field 206 can display a current unit price of the product A, which may change with the variation of the cumulative total quantity of the product A currently ordered by all purchasing parties. For example with reference to FIG. 3, once the cumulative total quantity of the product A currently ordered by all purchasing parties reaches the volume threshold value T1, the field 206 can change to display the discounted unit price of the product A associated therewith.

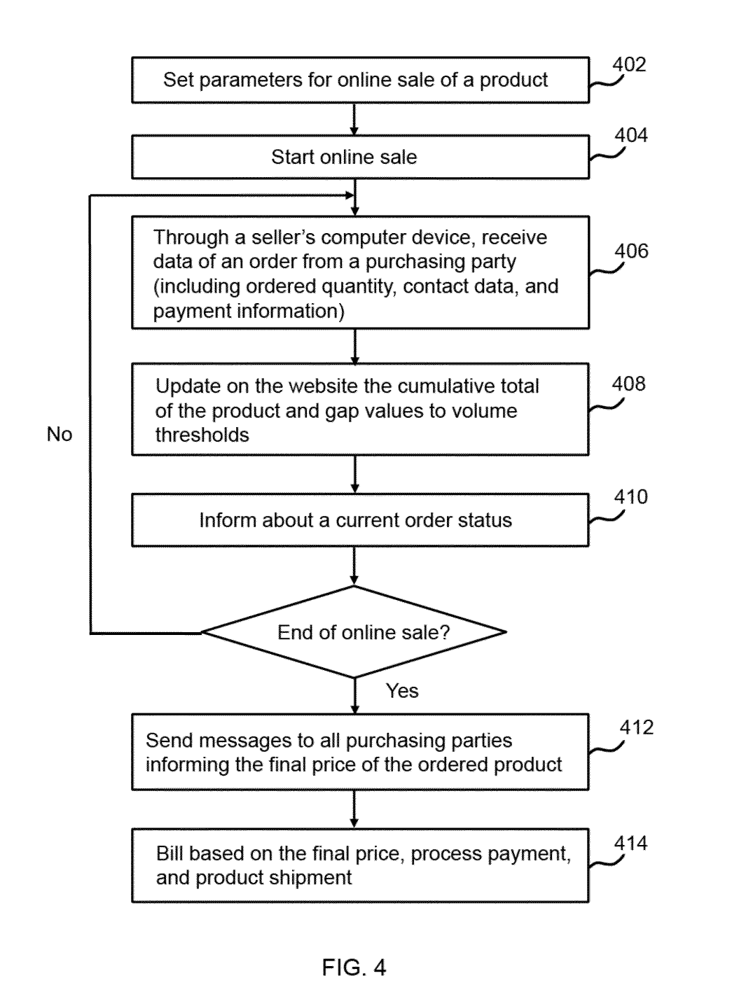

FIG. 4 is a flowchart illustrating method steps implemented through the system 100 to conduct online group purchase. In initial step 402, a selling party can use the seller's computing device 102 to set parameters for preparing the online sale of the product A. For example, an image of the product A can be displayed on the website 202, a time period of sale of the product A can set in the field 208, and an initial unit price of the product A can be set in the field 206. In addition, the volume threshold values T1 and T2 for group purchase discounts and the corresponding discounted prices P1 and P2 can be respectively set in the fields 222 and 224. In one embodiment, the product A can exemplary have two group purchase discounted prices: when the cumulative total quantity of the product A currently ordered by all purchasing parties since the beginning of the online sale of the product A reaches the volume threshold value T1, the selling price of the product A can be decreased to the discounted unit price P1; when the cumulative total quantity of the product A currently ordered by all purchasing parties since the beginning of the online sale of the product A reaches the volume threshold value T2 higher than T1, the selling price of the product A can be further decreased to the discounted unit price P2 lower than P1. It is understood that the selling party may set more or less discounted prices and volume thresholds as desired.

Once the sale parameters of the product A have been set up, the time counter 214 in next step 404 can start counting to start the online sale of the product A. In one embodiment, the time counter 214 can be displayed on the website 202. In other embodiments, the display of the time counter 214 can be omitted in the website 202.

In next step 406, a purchasing party can use one purchaser's terminal device 104 to place an order of the product A, and the seller's computer device 102 can receive and store data of the order transmitted from the purchaser's terminal device 104. In one embodiment, the data transmitted with the order from the purchaser's terminal device 104 to the seller's computer device 102 can include an order quantity, contact information, payment method, bank account and the like. Moreover, the data transmitted with the order can contain a purchase guarantee from the purchasing party, which may include payment information such as a credit card number. The payment information only serves as a guarantee, and no actual payment is processed until a final price of the product A is confirmed after the end of the online sale.

In step 408, according to the received order, the seller's computer device 102 can compute a cumulative total quantity of the product A currently ordered by all purchasing parties since the beginning of the online sale of the product A, and update in real time the field 220 on the website 202. The cumulative total quantity of the product A can be updated by summing the quantity of each new order received from a purchasing party. According to the cumulative total quantity of the product A, the seller's computer device 102 can also update in real time the fields 222A and 224A to display the current gaps between the volume threshold values T1, T2 and the cumulative total quantity of the product A currently ordered by all purchasing parties since the beginning of the online sale of the product A.

Subsequently, the seller's computer device 102 in step 410 can send a message to the purchaser's terminal devices 104 to notify a current order status of the product A. For example, assuming that the cumulative total quantity of the product A tracked in the field 220 has not reached the volume threshold value T1, the message can indicate that the initial unit price currently applies for the product A. In case the cumulative total quantity of the product A tracked in the field 220 has reached the volume threshold value T1, then the message can indicate that the discounted unit price P1 currently applies for the product A. Assuming that he cumulative total quantity of the product A tracked in the field 220 has reached the higher volume threshold value T2, then the message can indicate that the discounted unit price P2 currently applies for the product A. The aforementioned order status can be sent by the seller's computer device 102 to the purchaser's terminal devices 104 via emails or any forms of instantaneous text message applications.

Because the data (including the cumulative total quantity of the product A tracked in the field 220) displayed on the website 202 are updated in real time, any party can easily access to the website 202 to obtain the most recent status related to the sales of the product A. In some embodiments, the seller's computer device 102 may also notify in real time all purchasing parties about any price change of the product A as the cumulative total quantity tracked in the field 220 timely increases. For example, when the cumulative total quantity tracked in the field 220 reaches the volume threshold value T1 or T2, the seller's computer device 102 can automatically send a message to the purchaser's terminal devices 104 to notify that the selling price of the product A has decreased to the discounted unit price P1 or P2.

As long as the time counter 214 has not reached an end of the time period of sale preset for the product A, steps 406, 408 and 410 can be repeatedly performed.

When the time counter 214 has reached the end of the time period of sale preset for the product A, the seller's computer device 102 in step 412 can send a confirmation message to the terminal devices 104 of all purchasing parties so as to notify the final price of the product A. For example, assume that the cumulative total quantity of the product A has not reached the volume threshold value T1 at the end of the preset time period of sale, the final price of the product A is equal to the initial unit price. In case the cumulative total quantity of the product A has reached the volume threshold value T1 but is smaller than T2 at the end of the preset time period of sale, the final price of the product A is equal to the discounted unit price P1. In case the cumulative total quantity of the product A has reached the volume threshold value T2 at the end of the preset time period of sale, the final price of the product A is equal to the discounted unit price P2.

In one embodiment, when the time counter 214 has reached the end of the time period of sale preset for the product A, the online sale of the product A can be stopped, and/or order transactions related to the product A can be terminated.

Eventually, the computer device 102 in step 414 can perform a billing procedure based on the final price of the product A, process payment of all the orders, and proceed with product shipment. For example, the computer device 102 can send an invoice to each purchasing party with the final price of the order, communicate with a financial institution or a payment platform to confirm that a purchasing party has completed payment, verify the amount of the bill, and proceed with product shipment.

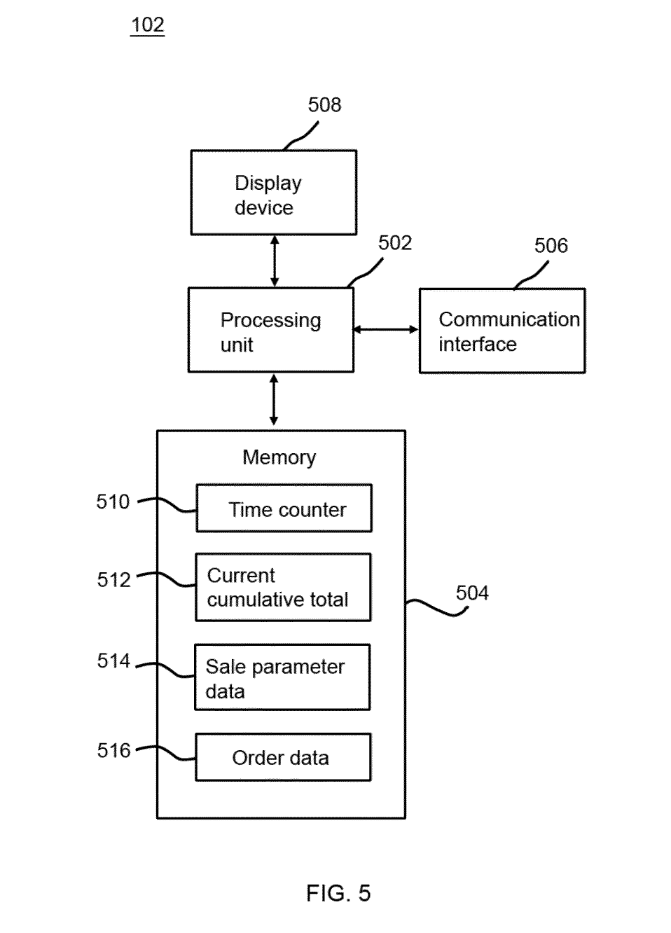

In conjunction with FIGS. 1-4, FIG. 5 is a schematic view illustrating an embodiment of the seller's computer device 102. The computer device 102 can exemplary include a processing unit 502, a memory 504, a communication interface 506 and a display device 508. The seller's computer device 102 can connect with the network 106 via the communication interface 506. The processing unit 502 can write data into the memory 504, read data from the memory 504, and run a program stored in the memory 504 to execute the aforementioned method steps of conducting group purchase.

In one embodiment, the memory 504 can store data such as data 510 of the time counter 214, data 512 of the cumulative total quantity of the product A tracked in the field 220, sale parameter data 514 for setting the online sale conditions of the product A, and order data 516. The parameter data 514 can include the time period of online sale for the product A, the initial unit price of the product A, the volume threshold values T1 and T2, the discounted unit prices P1 and P2, and the respective gaps between the volume threshold values T1, T2 and the cumulative total quantity of the product A tracked in the field 220. The order data 516 can include contact information of all purchasing parties, the order quantity of each purchasing party, payment information, etc. The processing unit 502 can receive an order of the product A from a purchaser's terminal device 104 via the communication interface 506, update in real time the data 512 of the cumulative total quantity of the product A ordered since the beginning of the sale of the product A, update in real time the fields 222A and 224A containing the values of the gaps between the volume threshold values T1, T2 and the cumulative total quantity of the product A, and send out updated data via the communication interface 506 for updating the website 202.

Advantages of the method and system described herein include the ability to update in real time the sale status of a product sold online. As a result, online group purchase can be facilitated, and more bargaining power can be offered to consumers for obtaining cheaper prices.

Realizations of the method and system of conducting online group purchase have been described in the context of particular embodiments. These embodiments are meant to be illustrative and not limiting. Many variations, modifications, additions, and improvements are possible. These and other variations, modifications, additions, and improvements may fall within the scope of the inventions as defined in the claims that follow.

What is claimed is:

1. A method of conducting online group purchase through a computer network including a seller's computer device and one or more purchaser's terminal device, the method comprising:
displaying on a website the image of a product, a time period of an online sale of the product, and a first unit price as a selling price of the product;
starting a time counter;
through the website, receiving an order of the product, and displaying a cumulative total quantity of the product currently ordered by all purchasing parties since the beginning of the online sale of the product;
according to the received order, updating in real time the cumulative total quantity of the product displayed on the website;
when the cumulative total quantity of the product reaches a volume threshold value, applying a second unit price as the selling price of the product, and displaying the second unit price on the website; and
when the time counter reaches an end of the online sale of the product, sending a confirmation message to one or more purchaser's terminal devices requesting payment for the ordered product calculated according to the second unit price.

2. The method according to claim 1, further including:
computing and displaying in real time on the website a current gap value between the volume threshold value and the cumulative total quantity of the product.

3. The method according to claim 1, further including:
displaying the time counter on the website.

4. The method according to claim 1, wherein the step of receiving an order of the product through the website includes:
recording the order of a purchasing party, which includes a quantity of the product ordered by the purchasing party, payment information, and contact data of the purchasing party; and
sending a first message to a terminal device of the purchasing party about a status of the order.

5. The method according to claim 1, further including:
as the cumulative total quantity of the product increases, timely informing all purchasing parties of the product about a change in the selling price of the product.

6. The method according to claim 1, wherein when the time counter reaches the end of the online sale of the product, stopping the sale of the product or terminating order transactions of the product.

7. The method according to claim 1, wherein the order of a purchasing party includes credit card information, and the method further includes holding off processing the payment of the order until the time period of the online sale has elapsed.

8. A system of conducting online group purchase, comprising:
a memory;
a communication interface; and
a processing unit operable to communicate with one or more purchaser's terminal device through the communication interface, the processing unit being operable to execute a computer program stored in the memory, wherein the computer program when executed causes the processing unit to:
display on a website the image of a product, a time period of an online sale of the product, and a first unit price as a selling price of the product;
start a time counter;
receive an order of the product, and display on the website a cumulative total quantity of the product currently ordered by all purchasing parties since the beginning of the online sale of the product;
according to the received order, update in real time the cumulative total quantity of the product displayed on the website;
when the cumulative total quantity of the product reaches a volume threshold value, apply and display a second unit price as the selling price of the product; and
when the time counter reaches an end of the online sale of the product, send a confirmation message to one or more purchaser's terminal devices requesting payment for the ordered product calculated according to the second unit price.

9. The system according to claim 8, wherein the computer program when executed further causes the processing unit to compute and display in real time on the website a current gap value between the volume threshold value and the cumulative total quantity of the product.

10. The system according to claim 8, wherein the computer program when executed further causes the processing unit to display the time counter on the website.

11. The system according to claim 8, wherein the computer program when executed further causes the processing unit to timely inform all purchasing parties of the product about a change in the selling price of the product, as the cumulative total quantity of the product increases.

12. The system according to claim 8, wherein when the time counter reaches the end of the online sale of the product, stopping the online sale of the product or terminating order transactions of the product.

13. The system according to claim 8, wherein the order of a purchasing party includes credit card information, and the computer program when executed further causes the processing unit to hold off processing the payment of the order until the online sale has elapsed.
